(19) United States
(12) Patent Application Publication
(10) Pub. No.: US 2021/0123150 A1
(43) Pub. Date: Apr. 29, 2021

(54) Semiconductor Photoelectrode

(71) Applicant: Nippon Telegraph and Telephone Corporation, Tokyo (JP)

(72) Inventors: Yuya Uzumaki, Musashino-shi, Tokyo (JP); Sayumi Sato, Musashino-shi, Tokyo (JP); Yoko Ono, Musashino-shi, Tokyo (JP); Takeshi Komatsu, Musashino-shi, Tokyo (JP)

(21) Appl. No.: 17/058,570

(22) PCT Filed: May 10, 2019
(86) PCT No.: PCT/JP2019/018749

§ 371 Date: Nov. 24, 2020

(30) Foreign Application Priority Data
May 29, 2018 (JP) 2018-102547

(51) Int. Cl. C25B 11/053; C25B 9/50; C25B 1/55; C25B 11/085; C25B 11/087

(52) U.S. Cl. CPC C25B 11/053; C25B 9/50; C25B 11/087; C25B 11/085; C25B 1/55

(57) ABSTRACT

To improve light energy conversion efficiency of a semiconductor photoelectrode. A semiconductor photoelectrode in which an oxidation reaction of water proceeds on a surface by irradiation with light includes a first semiconductor layer laminated on an insulating or conductive substrate, and a transparent conductive polymer layer laminated on the first semiconductor layer, made of a transparent conductive polymer, and having an activity function of promoting the oxidation reaction of water. Due to the transparency of the transparent conductive polymer layer, light transmittance is improved, and the transparent conductive polymer layer can be laminated on the entire surface of the semiconductor layer, allowing the light energy conversion efficiency of the semiconductor photoelectrode to be improved.

### TECHNICAL FIELD

The present invention relates to a semiconductor photoelectrode that performs an oxidation reaction of water with light energy.

### BACKGROUND ART

A decomposition reaction of water using a photocatalyst consists of an oxidation reaction of water and a reduction reaction of protons, which are each represented as follows:

2H₂O+4h⁺O₂+4H⁺ Oxidation reaction:

4H⁺+4e⁻→2H₂ Reduction reaction:

When an n-type photocatalytic material is irradiated with light, electrons and holes are generated and separated in the photocatalyst. The holes move to the surface of the photocatalytic material and contribute to the oxidation reaction of water. On the other hand, the electrons move to a reduction electrode and contribute to the reduction reaction of protons. Ideally, such a redox reaction proceeds and a decomposition reaction of water occurs.

FIG. 5 is a diagram illustrating a test device for performing a decomposition reaction of water with a semiconductor photoelectrode.

An oxidation tank 2 includes an aqueous solution 3 and an oxidation electrode 1 that is a semiconductor photoelectrode. The oxidation electrode 1 is in contact with the aqueous solution 3.

The aqueous solution 3 is, for example, an aqueous sodium hydroxide solution, an aqueous potassium hydroxide solution, or a hydrochloric acid. The oxidation electrode 1 is made of, for example, a nitride semiconductor, a titanium oxide, or an amorphous silicon.

A reduction tank 4 includes an aqueous solution 5 and a reduction electrode 6. The reduction electrode 6 is in contact with the aqueous solution 5. The aqueous solution 5 is, for example, an aqueous potassium hydrogen carbonate solution, an aqueous sodium hydrogen carbonate solution, an aqueous potassium chloride solution, or an aqueous sodium chloride solution. The reduction electrode 6 is made of a metal such as nickel, iron, gold, platinum, silver, copper, indium, or titanium, or a compound thereof.

A proton membrane 7 is sandwiched between the oxidation tank 2 and the reduction tank 4, and protons generated in the oxidation tank 2 diffuse into the reduction tank 4 through the proton membrane 7. The proton membrane 7 is made of, for example, Nafion (registered trademark) that is a perfluorocarbon material composed of a hydrophobic Teflon skeleton formed of carbon-fluorine and a perfluoro side chain having a sulfonic acid group.

The oxidation electrode 1 and the reduction electrode 6 are electrically connected by a conductive wire 8, and electrons are transferred from the oxidation electrode 1 to the reduction electrode 6.

A light source 9 is, for example, a xenon lamp, a mercury lamp, a halogen lamp, a pseudo sunlight source, sunlight, or a combination thereof. The light source 9 emits light having a wavelength that can be absorbed by the material constituting the oxidation electrode 1. For example, when the oxidation electrode 1 is made of gallium nitride, light having a wavelength of 365 nm or less that can be absorbed by gallium nitride is emitted.

FIG. 6 is a side view illustrating a structure of a conventional oxidation electrode 1. In the conventional oxidation electrode 1, an oxidation cocatalyst 20 made of nanoparticles of nickel oxide, platinum or the like is formed like an island on the upper surface of a semiconductor layer 12 laminated on a substrate 11 in order to promote an oxidation reaction of water performed in the semiconductor layer 12.

### CITATION LIST

### Non-Patent Literature

Non-Patent Literature 1: Satoshi Yotsuhashi, 6 others, “CO² Conversion with Light and Water by GaN Photoelectrode”, Japanese Journal of Applied Physics, 51, 2012, 02BP07-1 to 02BP07-3.
Non-Patent Literature 2: Soo Hee Kim, 3 others, “Improved efficiency and stability of GaN photoanode inphotoelectrochemical water splitting by NiO cocatalyst”, Applied Surface Science, 305, 2014, p. 638-p. 641.

### SUMMARY OF THE INVENTION

### Technical Problem

However, oxidation cocatalysts such as nickel oxide and platinum are low in light transmittance and thus cannot be formed on the entire surface of the semiconductor thin film, resulting in a coverage of approximately 1%. Therefore, light from the light source is not sufficiently transmitted to the semiconductor thin film, and generation of electrons and holes by photoexcitation is difficult to occur. In other words, the conventional semiconductor photoelectrode cannot fully utilize the performance of the oxidation cocatalyst, and there is a limit to the improvement in light energy conversion efficiency.

The present invention has been made in view of the above circumstances, and an object thereof is to improve the light energy conversion efficiency of a semiconductor photoelectrode.

### Means for Solving the Problem

In order to solve the above problems, a semiconductor photoelectrode of the present invention is the semiconductor photoelectrode in which an oxidation reaction of water proceeds on a surface by irradiation with light, which includes a first semiconductor layer laminated on an insulating or conductive substrate, and a transparent conductive polymer layer laminated on the first semiconductor layer, made of a transparent conductive polymer, and having an activity function of promoting the oxidation reaction of water.

Furthermore, the semiconductor photoelectrode of the present invention is the semiconductor photoelectrode in which an oxidation reaction of water proceeds on a surface by irradiation with light, which includes a first semiconductor layer laminated on an insulating or conductive substrate, a second semiconductor layer laminated on the first semiconductor layer and having a lattice constant of a plane perpendicular to a crystal growth direction that is smaller than that of the first semiconductor layer, and a transparent conductive polymer layer laminated on the second semiconductor layer, made of a transparent conductive polymer layer, and having an activity function of promoting the oxidation reaction of water.

### Effects of the Invention

According to the present invention, light energy conversion efficiency of a semiconductor photoelectrode can be improved.

### BRIEF DESCRIPTION OF DRAWINGS

FIG. 1 is a side view illustrating a structure of a semiconductor photoelectrode according to Example 1.

FIG. 2 is an enlarged view of an end portion of the semiconductor photoelectrode according to Example 1.

FIG. 3 is a side view illustrating a structure of the semiconductor photoelectrode according to Example 5.

FIG. 4 is an enlarged view of an end portion of the semiconductor photoelectrode according to Example 5.

FIG. 5 is diagram illustrating a test device that performs a decomposition reaction of water.

FIG. 6 is a side view illustrating a structure of a conventional semiconductor photoelectrode.

### DESCRIPTION OF EMBODIMENTS

Overview

In the present invention, a transparent conductive polymer layer made of a transparent conductive polymer and having an activity function of promoting an oxidation reaction of water is laminated on a semiconductor layer that is a photocatalyst. That is, the transparent conductive polymer is supported as an oxidation cocatalyst on the surface of the semiconductor layer that is a semiconductor photocatalyst.

Transparency of the transparent conductive polymer layer allows light transmittance to improve, and the transparent conductive polymer layer to be laminated on the entire surface of the semiconductor layer. In addition, since the transparent conductive polymer layer can be laminated on the entire surface of the semiconductor layer, the effective reaction area is increased as compared with the conventional one, and the oxidation reaction of water can be performed with high efficiency. As a result, light energy conversion efficiency of a semiconductor photoelectrode can be improved.

Hereinafter, an embodiment for carrying out the present invention will be described with reference to the drawings. It should be noted that the present invention is not limited to these embodiments, and modifications may be made without departing from the spirit of the present invention.

### Example 1

### (Structure of a Semiconductor Photoelectrode 1)

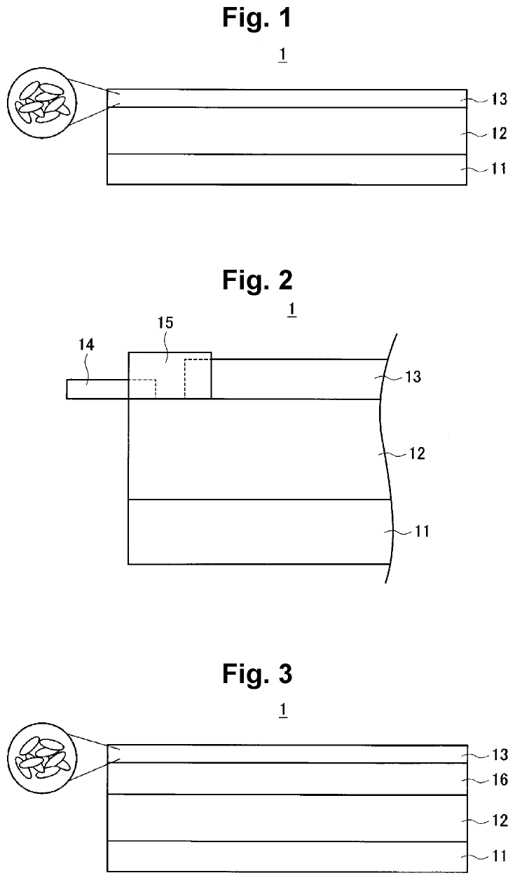

FIG. 1 is a side view illustrating a structure of the semiconductor photoelectrode 1 according to Example 1. As shown in FIG. 1, the semiconductor photoelectrode 1 includes a substrate 11, a first semiconductor layer 12, and a transparent conductive polymer layer 13.

The substrate 11 is an insulating or conductive substrate. In Example 1, the substrate 11 is configured by using a sapphire substrate. In place of the sapphire substrate, for example, a substrate such as a glass substrate, a Si substrate, or a GaN substrate may be used for configuration.

The first semiconductor layer 12 is a thin film laminated on the upper surface of the substrate 11, and is made of a photocatalytic material that causes an oxidation reaction of water when irradiated with light. The irradiation with light causes electrons and holes to be generated and separated inside the first semiconductor layer 12. The holes move to the upper side of the first semiconductor layer 12. The electrons move to a reduction electrode (not shown) that is connected to the first semiconductor layer 12.

In Example 1, the first semiconductor layer 12 is configured by using n-type gallium nitride (n-GaN). In place of the semiconductor layer using n-GaN, for example, a group III-V compound semiconductor using, for example, aluminum gallium nitride (AlGaN), indium gallium nitride (InGaN) or the like, a compound semiconductor using, for example, amorphous silicon or the like, or an oxide semiconductor using, for example, titanium oxide or the like may be used for configuration.

The transparent conductive polymer layer 13 is a thin film laminated on the upper surface of the first semiconductor layer 12. The transparent conductive polymer layer 13 is made of a transparent conductive polymer, and has an activity function of promoting an oxidation reaction of water. The transparent conductive polymer layer 13 is made of a cocatalyst material that acts as an oxidation cocatalyst for a photocatalytic material that is the first semiconductor layer 12.

In Example 1, the transparent conductive polymer layer 13 is configured by using poly(3,4-ethylenedioxythiophene):poly(styrene sulfonic acid) (PEDOT:PSS). In place of PEDOT:PSS, for example, any other hole transport material that transports holes and has a catalytic activity function on the surface, such as a copolymer of poly(3,4-ethylenedioxythiophene) (PEDOT) and a soluble polymer material, may be used for configuration.

(Method for Producing the Semiconductor Photoelectrode 1)

Next, a method for producing the semiconductor photoelectrode 1 according to Example 1 will be described.

First, a silicon-doped n-GaN (that is, the first semiconductor layer 12) is epitaxially grown on a sapphire (0001) having a thickness of 430 μm and a size of 2 inches by the metal organic vapor phase growth method. The film thickness of the n-GaN is 2 μm, which is sufficient to absorb light. At that time, the carrier (electron) density of the n-GaN was 3×10¹⁸ cm⁻³ due to doping of a silicon. Thereafter, the sapphire substrate having a size of 2 inches and the n-GaN are cleaved into four equal parts, and one of them is used as the semiconductor photoelectrode 1.

Next, an aqueous dispersion (Clevios P: manufactured by Heraeus) containing PEDOT:PSS (weight composition ratio=1:6) (that is, the transparent conductive polymer layer 13), whose concentration is adjusted so that a target film thickness is formed, is dropped on the surface of the n-GaN and spin-coated at 5,000 rpm for 30 seconds. Then, it is placed on a hot plate set at 110° C. and dried for 1 hour. Thereby, the transparent conductive polymer layer 13 provided with a porous structure in which a plurality of nanostructures are brought in tight contact can be obtained. The transparent conductive polymer layer 13 is porous and thus an increase in the reaction surface area can be expected.

The semiconductor photoelectrode 1 shown in FIG. 1 can be produced by the above production method. The film thickness of the produced transparent conductive polymer layer 13 was approximately 50 nm, and the light transmittance in a wavelength region of 300 nm or more was approximately 90% or more.

(Test Method and Test Result of the Redox Reaction)

Next, the test method and test result of the redox reaction will be described.

First, as shown in FIG. 2, a conductive wire 14 was connected to the exposed upper surface of a first semiconductor layer 12, and soldering was performed using indium (In). Then, it was coated with an epoxy resin 15 so that the surface of the indium would not be exposed and an area irradiated with light would be 1 cm². The semiconductor photoelectrode 1 thus obtained was used as the oxidation electrode 1 in FIG. 5.

In addition, in a test device shown in FIG. 5, as an aqueous solution 3 in an oxidation tank 2, a 1 mol/l aqueous sodium hydroxide solution was used. As an aqueous solution 5 in a reduction tank 4, a 0.5 mol/l aqueous potassium hydrogen carbonate solution was used. For a reduction electrode 6 and a proton membrane 7, platinum (manufactured by Nilaco) and Nafion were used, respectively.

Nitrogen gas was flowed into each reaction tank of an oxidation tank 2 and a reduction tank 4 at 10 ml/min, an area irradiated with sample light emitted from a light source 9 was 1 cm², and the aqueous solutions 3 and 5 were stirred by rotating a stirring bar and a stirrer at a rotational speed of 250 rpm at the central position of the bottom of each tank.

Then, after the air inside of each reaction tank was sufficiently replaced with the nitrogen gas, the light source surface of the light source 9 was fixed in such a manner that it faces a surface on which the first semiconductor layer 12 and a transparent conductive polymer layer 13 of the oxidation electrode 1 (that is, the semiconductor photoelectrode 1) was formed. As the light source 9, a 300 W high-pressure xenon lamp (having an illuminance of 5 mW/cm²) was used to uniformly irradiate the oxidation electrode 1 with light.

Thereafter, gas in each reaction tank was collected at an arbitrary time during irradiation with light, and the reaction product was analyzed by a gas chromatograph. As a result, it was confirmed that oxygen was generated in the oxidation tank 2 and hydrogen was generated in the reduction tank 4.

It should be noted that the aqueous solution 3 in the oxidation tank 2 used for the redox reaction test may be an aqueous potassium hydroxide solution or a hydrochloric acid in place of the aqueous sodium hydroxide solution. The aqueous solution 5 in the reduction tank 4 may be an aqueous sodium hydrogen carbonate solution, an aqueous potassium chloride solution, or an aqueous sodium chloride solution in place of the aqueous potassium hydrogen carbonate solution. Further, though the target product was hydrogen in Example 1, the target product can be changed by changing the reduction electrode 6 or an atmosphere in a cell. For example, by replacing the reduction electrode 6 made of platinum (Pt) with that of Ni, Fe, Au, Pt, Ag, Cu, In, Ti, Co, Ru or the like, it is possible to produce a carbon compound by a reduction reaction of carbon dioxide or to produce ammonia by a reduction reaction of nitrogen.

### Example 2

In Example 2, as in Example 1, the first semiconductor layer 12 was configured by using n-GaN, and the transparent conductive polymer layer 13 was configured by using PEDOT:PSS. The film thickness of the transparent conductive polymer layer 13 was approximately 100 nm, and the light transmittance in a wavelength region of 300 nm or more was approximately 90% or more. Other points are the same as in Example 1.

### Example 3

Also in Example 3, as in Example 1, the first semiconductor layer 12 was configured by using n-GaN, and the transparent conductive polymer layer 13 was configured by using PEDOT:PSS. The film thickness of the transparent conductive polymer layer 13 was approximately 1 μm, and the light transmittance in a wavelength region of 300 nm or more was approximately 85% or more. Other points are the same as in Example 1.

### Example 4

Also in Example 4, as in Example 1, the first semiconductor layer 12 was configured by using n-GaN, and the transparent conductive polymer layer 13 was configured by using PEDOT:PSS. The film thickness of the transparent conductive polymer layer 13 was approximately 5 μm, and the light transmittance in a wavelength region of 300 nm or more was approximately 70% or more. Other points are the same as in Example 1.

### Example 5

### (Structure of the Semiconductor Photoelectrode 1)

FIG. 3 is a side view illustrating a structure of the semiconductor photoelectrode 1 according to Example 5. As shown in FIG. 3, the semiconductor photoelectrode 1 includes the substrate 11, the first semiconductor layer 12, the second semiconductor layer 16, and the transparent conductive polymer layer 13.

The substrate 11 and the first semiconductor layer 12 both have the same structure and function as those of Example 1. In Example 5, as in Example 1, the substrate 11 is configured by using a sapphire substrate, and the first semiconductor layer 12 is configured by using n-GaN.

A second semiconductor layer 16 is a thin film laminated on the upper surface of the first semiconductor layer 12, and having a lattice constant of a plane perpendicular to the first semiconductor layer 12 or its own crystal growth direction (upward direction) that is smaller than that of the first semiconductor layer 12. The second semiconductor layer 16 is made of a photocatalytic material that causes an oxidation reaction of water when irradiated with light. In Example 5, the second semiconductor layer 16 is configured by using aluminum gallium nitride (AlGaN).

The transparent conductive polymer layer 13 is laminated on the upper surface of the second semiconductor layer 16 and has the same structure and function as those of Example 1. In Example 5, as in Example 1, the transparent conductive polymer layer 13 is configured by using PEDOT:PSS.

It should be noted that the first semiconductor layer 12 and the second semiconductor layer 16 may be configured by using a combination of III-V group compound semiconductors that use, for example, AlGaN, indium gallium nitride (InGaN) and the like.

(Method of Producing the Semiconductor Photoelectrode 1)

First, silicon-doped n-GaN (a lattice constant of a plane parallel to the sapphire substrate; 3.189 Å) (that is, the first semiconductor layer 12) is epitaxially grown on a sapphire (0001) with a size of 2 inches by the organic metal vapor phase growth method. The film thickness of the n-GaN is 2 μm, which is sufficient to absorb light. At this time, the carrier (electron) density of the n-GaN was 3×10¹⁸ cm⁻³ due to doping of silicon.

Thereafter, a gallium nitride (Al_{0.05}Ga_{0.9}N) (a lattice constant of a plane parallel to the sapphire substrate (that is, a plane perpendicular to the crystal growth direction); 3.185 Å) with a composition ratio of aluminum of 5% is grown. The film thickness of Al_{0.05}Ga_{0.9}N is 100 nm, which is sufficient to fully absorb light.

In this way, by forming a heterostructure in which a nitride semiconductor (AlGaN) having a smaller lattice constant in a plane perpendicular to the crystal growth direction is laminated on a nitride semiconductor (n-GaN), a large electric field is generated in the nitride semiconductor (AlGaN), which is the upper layer, due to the piezo effect caused by lattice distortion, which is expected to advantageously acts on the separation of electrons and holes. Note that the transparent conductive polymer layer 13 was formed in the same manner as in Example 1.

The semiconductor photoelectrode 1 shown in FIG. 3 can be generated by the above production method. The film thickness of the transparent conductive polymer layer 13 was about 50 nm, and the light transmittance in a wavelength region of 300 nm or more was approximately 90% or more.

(Test Method and Test Result of the Redox Reaction)

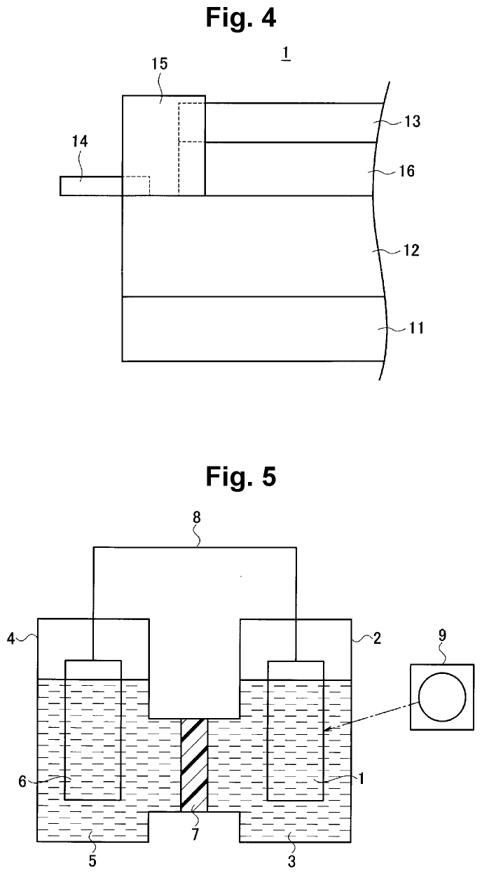

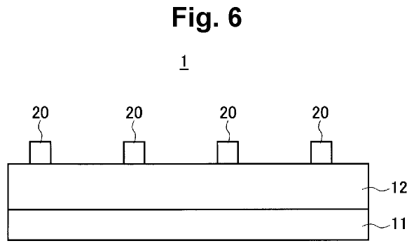

As shown in FIG. 4, the end portions of the transparent conductive polymer layer 13 and the second semiconductor layer 16 were scratched to expose the surface of the first semiconductor layer 12. The conductive wire 14 was connected to the exposed upper surface of the first semiconductor layer 12, and soldering was performed using indium. Then, it was coated with the epoxy resin 15 so that the surface of the indium would not be exposed. The semiconductor photoelectrode 1 thus obtained was used as the oxidation electrode 1 in FIG. 5, and thereafter, a redox reaction test was performed in the same manner as in Example 1.

### Example 6

In Example 6, as in Example 5, the first semiconductor layer 12 is configured by using n-GaN, the second semiconductor layer 16 is configured by using AlGaN, and the transparent conductive polymer layer 13 was configured by using PEDOT:PSS. The film thickness of the transparent conductive polymer layer 13 was approximately 100 nm, and the light transmittance in a wavelength region of 300 nm or more was approximately 90% or more. Other points are the same as those in Example 5.

### Example 7

Also in Example 7, as in Example 5, the first semiconductor layer 12 is configured by using GaN, the second semiconductor layer 16 is configured by using AlGaN, and the transparent conductive polymer layer 13 was configured by using PEDOT:PSS. The film thickness of the transparent conductive polymer layer 13 was approximately 1 μm, and the light transmittance in a wavelength region of 300 nm or more was about 85% or more. Other points are the same as in Example 5.

### Example 8

Also in Example 8, as in Example 5, the first semiconductor layer 12 was configured by using n-GaN, the second semiconductor layer 16 was configured by using AlGaN, and the transparent conductive polymer layer 13 was configured by using PEDOT:PSS. The film thickness of the transparent conductive polymer layer 13 was approximately 5 μm, and the light transmittance in a wavelength region of 300 nm or more was approximately 70% or more. Other points are the same as in Example 5.

### Comparative Example 1

In contrast to Example 1, the semiconductor photoelectrode 1 was produced without forming the transparent conductive polymer layer 13. Other points are the same as in Example 1.

### Comparative Example 2

In contrast to Example 1, instead of forming the transparent conductive polymer layer 13, the semiconductor photoelectrode 1 was produced by forming nanoparticles of nickel oxide (NiO) as an oxidation cocatalyst. A MOD (Metal Organic Decomposition) coating material (SYM-NI05: manufactured by SYMETRIX), whose concentration was adjusted so as to form a target film thickness, was spin-coated (at 5,000 rpm, for 30 seconds) on the surface of the semiconductor thin film. The MOD coating material is a solution in which a metal organic compound is dissolved in an organic solvent. Then, after calcining on a 110° C. hotplate, this semiconductor thin film was heat-treated at 500° C. in an oxygen atmosphere for 2 hours by using an electric furnace. As a result, a porous layer in which nano-sized NiO particles are gathered was formed with a thickness of approximately 5 nm, and the light transmittance in a wavelength region of 300 nm or more was approximately 85% or more. Other points are the same as in Example 1.

### Comparative Example 3

In contrast to Example 1, instead of forming the transparent conductive polymer layer 13, the semiconductor photoelectrode 1 was produced by forming nanoparticles of NiO as an oxidation cocatalyst. The thickness of the NiO was approximately 10 nm, and the light transmittance in a wavelength region of 300 nm or more was approximately 30% or less. Other points are the same as in Example 1.

### Comparative Example 4

In contrast to Example 1, instead of forming the transparent conductive polymer layer 13, the semiconductor photoelectrode 1 was produced by forming nanoparticles of NiO as an oxidation cocatalyst. The thickness of the NiO was approximately 50 nm, and the light transmittance in a wavelength region of 300 nm or more was approximately 5% or less. Other points are the same as in Example 1.

### Comparative Example 5

In contrast to Example 5, the semiconductor photoelectrode 1 was produced without forming the transparent conductive polymer layer 13. Other points are the same as in Example 5.

### Comparative Example 6

In contrast to Example 5, instead of forming the transparent conductive polymer layer 13, the semiconductor photoelectrode 1 was produced by forming nanoparticles of NiO as an oxidation cocatalyst. The thickness of the NiO was approximately 5 nm, and the light transmittance in a wavelength region of 300 nm or more was approximately 85% or more. Other points are the same as in Example 5.

### Comparative Example 7

In contrast to Example 5, instead of forming the transparent conductive polymer layer 13, the semiconductor photoelectrode 1 was produced by forming nanoparticles of NiO as an oxidation cocatalyst. The thickness of the NiO was approximately 10 nm, and the light transmittance in a wavelength region of 300 nm or more was approximately 30% or less. Other points are the same as in Example 5.

### Comparative Example 8

In contrast to Example 5, instead of forming the transparent conductive polymer layer 13, the semiconductor photoelectrode 1 was produced by forming nanoparticles of NiO as an oxidation cocatalyst. The thickness of the NiO was approximately 50 nm, and the light transmittance in a wavelength region of 300 nm or more was approximately 5% or less. Other points are the same as in Example 5.

### Effect of Examples

The amounts of respective gases of oxygen and hydrogen produced in Examples 1 to 8 and Comparative Examples 1 to 8 are shown in Table 1. “Semiconductor thin film” in Table 1 indicates the first semiconductor layer 12 and the second semiconductor layer 16. “Oxidation cocatalyst” in Table 1 indicates the transparent conductive polymer layer 13.

TABLE 1

| | | | Thickness | | Gas production | |
|---|---|---|---|---|---|---|
| | | | of | | amount in a | |
| | | | oxidation | Light | cell/μmol · | |
| | Semiconductor | Oxidation | cocatalyst | transmittance | cm⁻² · h⁻¹ | |
| Example | thin film | cocatalyst | (nm) | (%) | Oxygen | Hydrogen |
| Example 1 | n-GaN | PEDOT:PSS | 48 | 92 | 3.1 | 6.4 |
| Example 2 | n-GaN | PEDOT:PSS | 106 | 91 | 5.8 | 11.2 |
| Example 3 | n-GaN | PEDOT:PSS | 1046 | 86 | 8.4 | 17.1 |
| Example 4 | n-GaN | PEDOT:PSS | 5090 | 73 | 4.1 | 8.5 |
| Example 5 | AlGaN/n-GaN | PEDOT:PSS | 52 | 92 | 5.2 | 10.6 |
| Example 6 | AlGaN/n-GaN | PEDOT:PSS | 109 | 90 | 8.5 | 17.4 |
| Example 7 | AlGaN/n-GaN | PEDOT:PSS | 996 | 87 | 9.6 | 19.4 |
| Example 8 | AlGaN/n-GaN | PEDOT:PSS | 5035 | 74 | 6.2 | 13.0 |
| Comparative | n-GaN | None | 0 | 100 | 1.5 | 3.6 |
| Example 1 | | | | | | |
| Comparative | n-GaN | NiO | 5 | 85 | 2.6 | 6.1 |
| Example 2 | | | | | | |
| Comparative | n-GaN | NiO | 10 | 29 | 1.2 | 2.5 |
| Example 3 | | | | | | |
| Comparative | n-GaN | NiO | 51 | 4 | Unable | Unable |
| Example 4 | | | | | to | to |
| | | | | | detect | detect |
| Comparative | AlGaN/n-GaN | None | 0 | 100 | 3.1 | 6.5 |
| Example 5 | | | | | | |
| Comparative | AlGaN/n-GaN | NiO | 5 | 85 | 5.4 | 10.9 |
| Example 6 | | | | | | |
| Comparative | AlGaN/n-GaN | NiO | 11 | 28 | 2.1 | 4.2 |
| Example 7 | | | | | | |
| Comparative | AlGaN/n-GaN | NiO | 49 | 3 | Unable | Unable |
| Example 8 | | | | | to | to |
| | | | | | detect | detect |

When the amounts of gas produced in Example 1 and Comparative Example 1 are compared, Example 1 having PEDOT:PSS produces more gases. Accordingly, it can be said that PEDOT:PSS allowed the oxidation cocatalyst function to act effectively and light energy conversion efficiency of the semiconductor photoelectrode 1 to be improved. This is also the same when Example 5 and Comparative Example 5 are compared.

In addition, from the gas production amounts of Examples 1 to 4, it was found that the film thickness of PEDOT:PSS is preferably approximately 1 μm. From this, it was found that the light transmittance of PEDOT:PSS is desirably 80% or more. This was also the same when Examples 5 to 8 were compared. It is considered that as the PEDOT:PSS film thickness increased, the reaction surface area increased and thus the gas production amounts increased. On the other hand, it is considered that when the film thickness of PEDOT:PSS was too thick, a reduction in light absorption in the semiconductor thin film due to a large decrease in the light transmittance resulted in a reduction of produced gasses in Examples 4 and 8. From this, it was found that a larger surface area is desirable in a range region where PEDOT:PSS sufficiently transmits light.

The comparison result of the gas production amounts of Comparative Examples 1 and 2 as well as the comparison result of the gas production amounts of Comparative Examples 5 and 6 show that NiO has an oxidation cocatalyst function. On the other hand, it was found from the comparison result of the gas production amounts of Comparative Examples 2 to 4 that the gas production amounts decrease as the NiO film thickness increases. This is also the same with Comparative Examples 6 to 8 from the comparison result of their gas production amounts. Although the reaction surface area increased with the increase in the NiO film thickness, it is considered that the decrease in light absorption in the semiconductor thin film due to the reduction in the light transmittance had a larger effect.

When the gas production amounts of Example 1 and Comparative Example 4 are compared, although the film thicknesses of both oxidation cocatalysts were nearly the same, gas production was not able to be detected in Comparative Example 4 while improvement of gas production was confirmed in Example 1. This was the same when the gas production amounts were compared between Example 5 and Comparative Example 8. This is considered to be because, in the case of PEDOT:PSS, even if the reaction surface area was increased, it was possible to maintain the light transmittance at or above a certain level.

When the gas production amounts of Example 3 and Comparative Example 2 were compared, it was found that although they had almost the same level of light transmittance, the gas production amount of Example 3 improved by 4 times as compared with the gas production amount of Comparative Example 2. This was the same when the gas production amounts of Example 7 and Comparative Example 6 were compared. This result is considered to be the effect of the increase in the reaction surface area of the oxidation cocatalyst.

### Effect of the Invention

In this way, according to Examples 1 to 4, since the first semiconductor layer 12 that is a photocatalyst is made of a transparent conductive polymer and is laminated with the transparent conductive polymer layer 13 having an activity function of promoting an oxidation reaction of water, the light transmittance is improved due to the transparency of the transparent conductive polymer layer 13 (that is, it is possible to prevent a reduction in the amount of light absorbed by the semiconductor photocatalyst due to light shielding by the cocatalyst material), and the transparent conductive polymer layer can be laminated on the entire surface of the semiconductor layer. Furthermore, since the transparent conductive polymer layer can be laminated on the entire surface of the semiconductor layer, an effective reaction area is increased as compared with the conventional one, and an oxidation reaction of water can be performed with high efficiency. As a result, light energy conversion efficiency of the semiconductor photoelectrode can be improved.

Furthermore, according to Examples 5 to 8, since the second semiconductor layer 16 having a lattice constant of a plane perpendicular to a crystal growth direction that is smaller than that of the first semiconductor layer 12 is laminated on the first semiconductor layer 12 that is a photocatalyst, the first semiconductor layer 12 and the second semiconductor layer 16 are formed in a heterostructure. As a result, a large electric field is generated in the second semiconductor layer 16 due to the piezo effect caused by lattice distortion, which advantageously acts on the separation of electrons and holes, thereby allowing the light energy conversion efficiency of the semiconductor photoelectrode to be further improved.

### REFERENCE SIGNS LIST

1 Semiconductor photoelectrode, oxidation electrode
11 Substrate
12 First semiconductor layer
13 Transparent conductive polymer layer
14 Conductive wire
15 Epoxy resin
16 Second semiconductor layer
2 Oxidation tank
3 Aqueous solution
4 Reduction tank
5 Aqueous solution
6 Reduction electrode
7 Proton membrane
8 Conductive wire
9 Light source
20 Oxidation cocatalyst

1. A semiconductor photoelectrode in which an oxidation reaction of water proceeds on a surface by irradiation with light, comprising;
a first semiconductor layer laminated on an insulating or conductive substrate; and
a transparent conductive polymer layer laminated on the first semiconductor layer, made of a transparent conductive polymer, and having an activity function of promoting the oxidation reaction of water.

2. A semiconductor photoelectrode in which an oxidation reaction of water proceeds on a surface by irradiation with light, comprising
a first semiconductor layer laminated on an insulating or conductive substrate;
a second semiconductor layer laminated on the first semiconductor layer and having a lattice constant of a plane perpendicular to a crystal growth direction that is smaller than that of the first semiconductor layer; and
a transparent conductive polymer layer laminated on the second semiconductor layer, made of a transparent conductive polymer, and having an activity function of promoting the oxidation reaction of water.
